(19) United States
(12) Patent Application Publication
(10) Pub. No.: US 2024/0266642 A1
(43) Pub. Date: Aug. 8, 2024

(54) BATTERY HOUSING, LITHIUM BATTERY AND ELECTRONIC PRODUCT THEREOF

(71) Applicant: HUIZHOU LIWINON NEW ENERGY TECHNOLOGY CO., LTD, Huizhou (CN)

(72) Inventors: Kelin ZHANG, Huizhou (CN); Xianrui CHEN, Huizhou (CN); Bing HAN, Huizhou (CN); Rongjin JI, Huizhou (CN); Cong LI, Huizhou (CN); Shan YANG, Huizhou (CN); Jie CHEN, Huizhou (CN)

(21) Appl. No.: 18/638,732

(22) Filed: Apr. 18, 2024

Related U.S. Application Data
(63) Continuation of application No. PCT/CN2022/125295, filed on Oct. 14, 2022.

(30) Foreign Application Priority Data
Oct. 19, 2021 (CN) 202122515309.2

(51) Int. Cl. H01M 50/103; H01M 10/052; H01M 50/133; H01M 50/15; H01M 50/169; H01M 50/176; H01M 50/55; H01M 50/553; H01M 50/562; H01M 50/627

(52) U.S. Cl. CPC H01M 50/103; H01M 10/052; H01M 50/133; H01M 50/15; H01M 50/169; H01M 50/176; H01M 50/55; H01M 50/553; H01M 50/562; H01M 50/627; H01M 2220/30

(57) ABSTRACT

Disclosed are a battery housing, a lithium battery and an electronic product thereof. The battery housing includes a housing, a first cover plate and a second cover plate, an accommodation cavity being formed in the housing, an upper end and a lower end of the housing each being open, and a first through hole being formed in a side wall of the housing; the first cover plate is fixedly mounted at the upper end of the housing, the first cover plate covering the opening at the upper end of the housing; the second cover plate is fixedly mounted at the lower end of the housing, the second cover plate covering the opening at the lower end of the housing.

### TECHNICAL FIELD

The present disclosure belongs to the technical field of battery manufacturing, and specifically relates to a battery housing, a lithium battery and an electronic product thereof.

### BACKGROUND

Increasing functions of a cellphone result in an increase in power consumption, and battery capacity is required to increase accordingly. In order to make the cellphone miniaturized, making a battery reduced and thinning becomes the most effective way. The battery with a thickness of less than 4 mm is expected to become the mainstream trend for slim cellphones. Similarly, other electronic devices such as laptops, Bluetooth handsets, and portable DVDs are all developing towards mobility and portability, they are all equipped with LCD displays and have increasing functions, and the LCD displays thereof become larger, posing higher requirements for the overall energy density of batteries.

Compared with the commonly used aluminum-plastic film pouch batteries, the existing steel-housing batteries for cellphones have the following advantages:
1. reducing widths of top and side sealing edges, increasing space utilization and enhancing energy density of the batteries; and
2. good safety performance, and higher reliability of battery cells in extreme environments.

Therefore, the steel-housing batteries have broad development prospects. However, the current steel-housing batteries for cellphones usually adopt housing structures with flange edges, as shown in FIG. 1, protruding flange edges thereof will reduce the overall energy density of the battery, an R-corner area at the top of the battery housing will press a battery cell, affecting the safety performance of the battery cell.

### SUMMARY

Objectives of the present disclosure are to provide a battery housing, a lithium battery and an electronic product thereof, to solve the problems of low energy density of existing steel-housing batteries, improve an overall energy density of the steel-housing batteries, and avoiding the risk of an R-corner area at the top of the battery housing pressing a battery cell.

To achieve the foregoing objectives, the present disclosure adopts the following technical solution, a battery housing, including:
a housing, a first cover plate and a second cover plate, an accommodation cavity is formed inside the housing, an upper end and a lower end of the housing each has an opening, and a first through hole is formed on a side wall of the housing; the first cover plate is fixedly mounted at the upper end of the housing, the first cover plate covers the opening at the upper end of the housing; and the second cover plate is fixedly mounted at the lower end of the housing, the second cover plate covers the opening at the lower end of the housing.

Further, at least one of the first cover plate and the second cover plate is provided with an explosion-proof device.

Further, a liquid injection hole is formed on the side wall of the housing.

Further, the first cover plate and the second cover plate can be a rectangular structure or a circular structure.

Further, the housing has a thickness of 0.05-0.5 mm.

A lithium battery, including the battery housing, a battery cell, a first connecting member and a second connecting member, the battery cell is fixedly mounted inside the accommodating cavity, the first connecting member is inserted into the first through hole, and the second connecting member is fixedly mounted on the housing.

As an improvement of the lithium battery in the present disclosure, the battery cell is provided with a first tab and a second tab, the first tab is electrically connected to the first connecting member, and the second tab is electrically connected to the housing.

As an improvement of the lithium battery in the present disclosure, the first connecting member includes a connecting piece, a first insulating piece, a second insulating piece and a pole, the connecting piece and the first insulating piece are fixedly installed inside the housing, the second insulating piece is fixedly installed outside the housing, and the pole sequentially passes through the second insulating piece, the first through hole, the first insulating piece and the connecting piece.

As an improvement of the lithium battery in the present disclosure, the second connecting member is a nickel sheet.

An electronic product, including the lithium battery above.

The present disclosure has the following beneficial effects: the battery housing includes a housing, a first cover plate and a second cover plate, an accommodation cavity being formed in the housing, the upper end and the lower end of the housing each being open, and a first through hole being formed in the side wall of the housing; the first cover plate is fixedly mounted at the upper end of the housing, the first cover plate covering the opening at the upper end of the housing; the second cover plate is fixedly mounted at the lower end of the housing, the second cover plate covering the opening at the lower end of the housing. In the present disclosure, the first cover plate and the second cover plate are respectively matched with the upper end and the lower end of the housing, the first cover plate and the second cover plate are welded with the housing to form an integrated body by adopting laser welding technology, so that the accommodation cavity forms a sealed space, and the housing does not need to be provided with a flange edge, thereby improving overall energy density of the battery; further, since the first cover plate and the second cover plate are used to seal the upper end and the lower end of the housing, respectively, contact surfaces between the housing and the first cover plate, and between the housing and the second cover plate are in a horizontal state. Compared with existing battery housings, the housing in the present disclosure does not need to be provided with an arc-shaped transition surface, avoiding the risk of an R-corner area at the top of the battery housing pressing a battery cell, and increasing use safety of the battery.

### BRIEF DESCRIPTION OF THE DRAWINGS

FIG. 1 is a schematic diagram of a housing structure of an existing cellphone steel-housing battery.

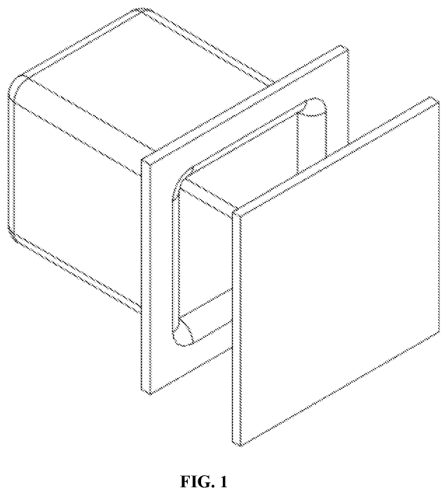

FIG. 2 is a structural schematic diagram 1 of a battery housing in Embodiment 1 according to the present disclosure.

FIG. 3 is a structural schematic diagram 2 of a battery housing in Embodiment 1 according to the present disclosure.

FIG. 4 is a structural schematic diagram 1 of a lithium battery in Embodiment 2 according to the present disclosure.

FIG. 5 is a structural schematic diagram 2 of a lithium battery in Embodiment 2 according to the present disclosure.

FIG. 6 is a structural schematic diagram 3 of a lithium battery in Embodiment 2 according to the present disclosure.

FIG. 7 is a structural schematic diagram 4 of a lithium battery in Embodiment 2 according to the present disclosure.

Reference numerals in the accompanying drawings: 1—housing; 11—through hole; 12—liquid injection hole; 2—first cover plate; 3—second cover plate; 4—battery cell; 5—first connecting member; 51—connecting piece; 52—first insulating piece; 53—second insulating piece; 54—pole; 6—second connecting member; and 7—sealing plug.

### DETAILED DESCRIPTIONS OF THE EMBODIMENTS

In the description of the present disclosure, it is to be understood that the terms “upper”, “lower”, “front”, “back”, “left”, “right”, “top”, “bottom”, “inner”, “outer”, etc. indicate azimuthal or positional relations on the basis of those shown in the drawings only for ease of description of the present disclosure and for simplicity of description, and are not intended to indicate or imply that the referenced device or element must have a particular orientation and be constructed and operative in a particular orientation, and thus may not be construed as a limitation on the present disclosure.

In the description of the present disclosure, unless otherwise explicitly specified and defined, the terms “first”, “second” and “third” are used for descriptive purposes only and should not be construed as indicating or implying a relative importance; the term “a plurality of” refers to at least two or more; and unless otherwise specified or defined, the terms “connected” and “fixed” should be understood in a broad sense, for example, “connected” may be a fixed connection, a detachable connection, or an integrated connection, or an electrical connection; and “connection” may be a direct connection, or an indirect connection via an intermediate medium. For those of ordinarily skilled in the art, specific meanings of the above terms in the present disclosure could be understood according to specific circumstances.

In the present disclosure, unless otherwise explicitly specified and defined, the terms “mounting”, “connecting”, “connection”, “fixing”, etc. should be understood in a broad sense, for example, they may be a fixed connection, a detachable connection, or an integrated connection; may be a mechanical connection, or an electrical connection; may be a direct connection, or an indirect connection via an intermediate medium; and may be communication inside two elements, or an interactive relation between two elements. For those of ordinarily skilled in the art, the specific meanings of the terms described above in the present disclosure may be interpreted according to specific circumstances.

### Embodiment 1

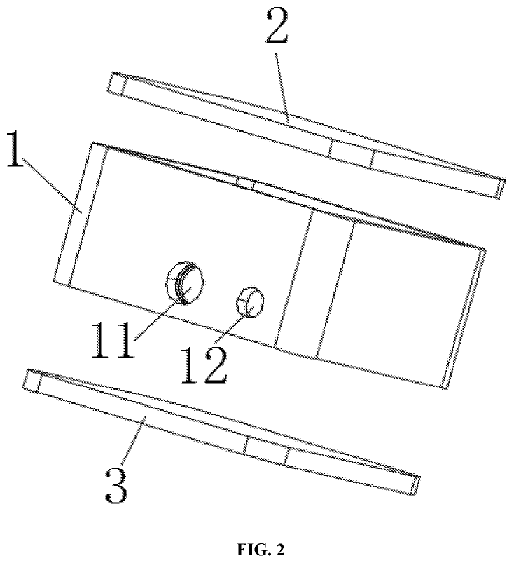

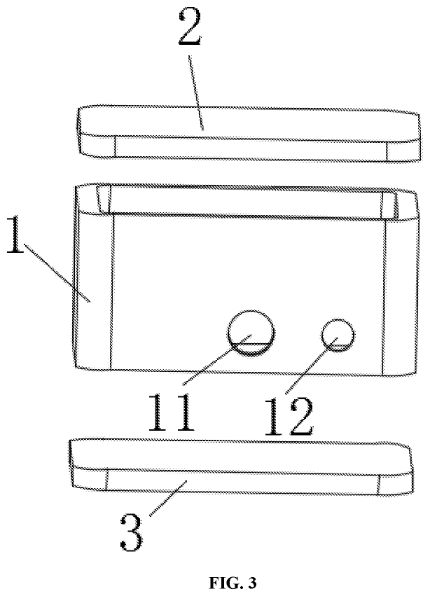

As shown in FIGS. 2-3, Embodiment 1 provides a battery housing, including a housing 1, a first cover plate 2 and a second cover plate 3, an accommodation cavity is formed in the housing 1, an upper end and a lower end of the housing 1 each has an opening, and a first through hole 11 is formed in a side wall of the housing 1; the first cover plate 2 is fixedly mounted at the upper end of the housing 1, the first cover plate 2 covers the opening at the upper end of the housing 1; and the second cover plate 3 is fixedly mounted at the lower end of the housing 1, the second cover plate 3 covers the opening at the lower end of the housing 1. In the present disclosure, the first cover plate 2 and the second cover plate 3 are respectively matched with the upper end and the lower end of the housing 1, the first cover plate 2 and the second cover plate 3 are welded with the housing 1 to form an integrated body by adopting laser welding technology, so that the accommodation cavity forms a sealed space, and the housing 1 does not need to be provided with a flange edge, thereby improving overall energy density of the battery; further, since the first cover plate 2 and the second cover plate 3 are used to seal the upper end and the lower end of the housing 1, respectively, contact surfaces between the housing 1 and the first cover plate 2, and between the housing 1 and the second cover plate 3 are in a horizontal state. Compared with existing battery housings, the housing in the present disclosure does not need to be provided with an arc-shaped transition surface, avoiding the risk of an R-corner area at the top of the battery housing pressing a battery cell 4, and increasing use safety of the battery.

Preferably, in order to avoid an explosion accident occurs in a lithium battery caused by a sharp increase in an internal pressure of the lithium battery caused by a large amount of gas generated inside the lithium battery when the lithium battery suffers abnormality, at least one of the first cover plate 2 and the second cover plate 3 is provided with an explosion-proof device, specifically, the explosion-proof device is an explosion-proof valve or an explosion-proof pattern, and the explosion-proof device is not limited to types defined in Embodiment 1, and can also be selected from the prior art according to actual needs.

Preferably, a liquid injection hole 12 is formed on the side wall of the housing 1, and the liquid injection hole 12 is configured to facilitate the injection of electrolyte. In Embodiment 1, the liquid injection hole 12 and the first through hole 11 are arranged side by side, the liquid injection hole 12 has a cylindrical structure with a sealing plug 7 inserted inside, the sealing plug 7 is of a T-shaped structure and includes a plug cap and a plug body, a diameter of the plug cap is greater than that of the plug body, and the diameter of the plug body is greater than that of the liquid injection hole 12; and when the liquid injection is completed, the plug body is inserted into the liquid injection hole 12, and the plug body and the liquid injection hole 12 are matched in an interference fit manner, such structural design enhances the sealing performance of the housing 1 and prevents the electrolyte in the housing 1 from contacting with air outside.

In Embodiment 1, a length of the first cover plate 2 equals to that of an upper end surface of the housing 1, a width of the first cover plate 2 equals to that of the upper end surface of the housing 1, a length of the second cover plate 3 equals to that of a lower end surface of the housing 1, a width of the second cover plate 3 equals to that of the lower end surface of the housing 1, structures of the first cover plate 2 and the second cover plate 3 are matched with the structural design of the housing 1, and can be a rectangular structure or a circular structure, thereby ensuring the first cover plate 2 and the second cover plate 3 are completely covered at the upper and lower ends of the housing 1.

Further, the housing 1 has a thickness of 0.05-0.5 mm. With this structural design, the housing 1 can ensure the safety of the battery cell 4 installed inside the housing, and can also reduce a volume of the battery and improve an overall energy density of the battery.

### Embodiment 2

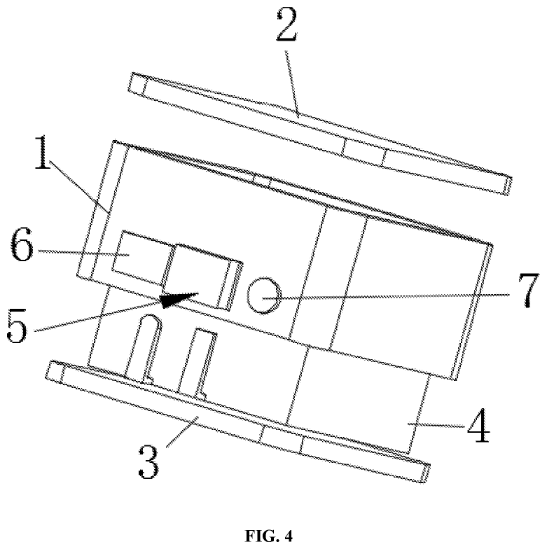

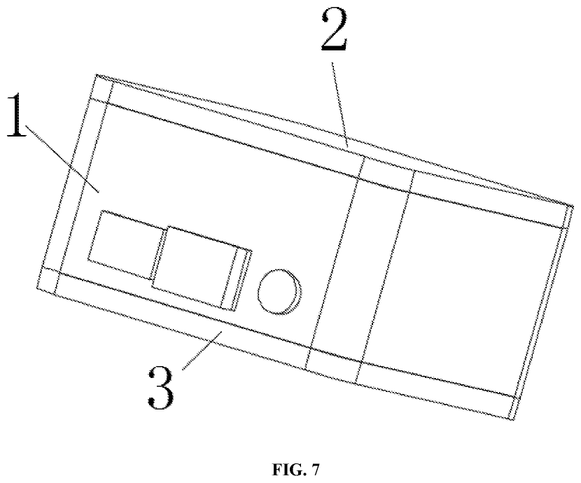

As shown in FIGS. 4-7, Embodiment 2 provides a lithium battery, including the battery housing in Embodiment 1, the battery cell 4, a first connecting member 5 and a second connecting member 6, the battery cell 4 is fixedly mounted inside the accommodating cavity, the first connecting member 5 is inserted into the first through hole 11, and the second connecting member 6 is fixedly mounted on the housing 1.

Specifically, the battery cell 4 includes a positive electrode piece, a separator and a negative electrode piece, the battery cell 4 is formed by sequentially stacking and winding the negative electrode piece, the separator and the positive electrode piece, or the battery cell 4 is formed by sequentially stacking the negative electrode piece, the separator and the positive electrode piece.

Preferably, the battery cell 4 is provided with a first tab and a second tab, the first tab is electrically connected to the first connecting member 5, and the second tab is electrically connected to the housing 1.

Preferably, the first connecting member 5 includes a connecting piece 51, a first insulating piece 52, a second insulating piece 53 and a pole 54, the connecting piece 51 and the first insulating piece 52 are fixedly installed inside the housing 1, the second insulating piece 53 is fixedly installed outside the housing 1, and the pole 54 sequentially passes through the second insulating piece 53, the first through hole, the first insulating piece 52 and the connecting piece 51. Specifically, the connecting piece 51 and the pole 54 are both made of aluminum material, the first insulating piece 52 and the second insulating piece 53 are made of any one or a combination of, including but not limited to: natural rubber, styrene butadiene rubber, polybutadiene rubber, chloroprene rubber, polyisoprene rubber, nitrile butadiene rubber, butyl rubber, ethylene propylene rubber, polyurethane rubber, chlorosulfonated polyethylene rubber, chlorinated polyethylene rubber, silicone rubber, fluorine rubber, polysulfide rubber, polyacrylate rubber, polyether rubber, hydrogenated nitrile rubber, fluoro-phosphazene rubber, perfluoroether rubber, triazine rubber, boron silicone rubber, polyvinylidene chloride resin, polyvinylidene fluoride resin, polystyrene resin, nylon resin, polymethyl methacrylate resin, polycarbonate resin, polytetrafluoroethylene, polyurethane, ABS resin, vinyl acetate resin, polyvinyl chloride resin, polyurethane thermoplastic elastomer, polyolefin thermoplastic elastomer, styrene thermoplastic elastomer and polyester thermoplastic elastomer.

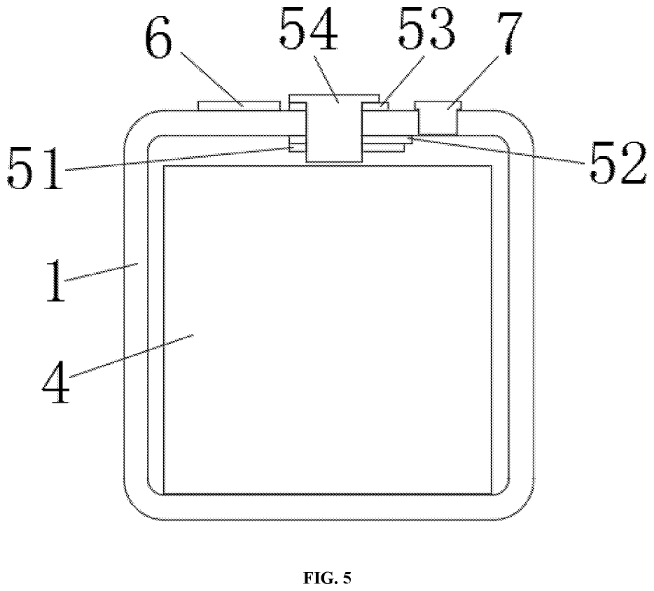

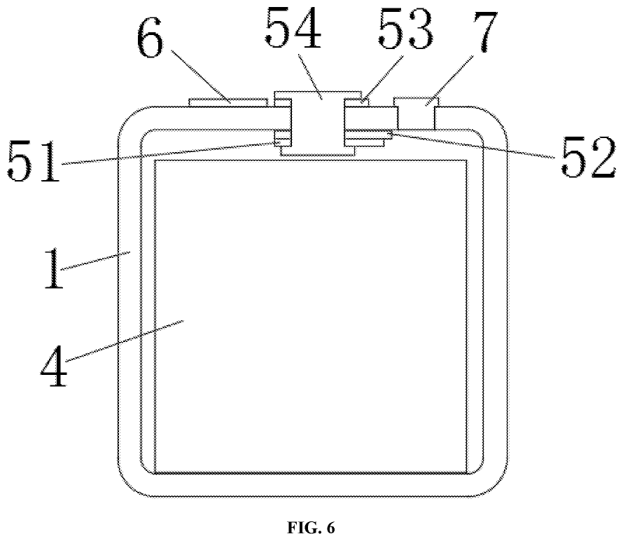

As shown in FIGS. 5-6, the present disclosure provides a lithium battery, the pole 54 passes through the connecting piece 51 and partially extends into the accommodating cavity; when a hot-press forming process (riveting) is adopted, the pole 54 changes from a T-shaped structure to an I-shaped structure, such that the structural firmness and sealing performance of the battery are improved.

Preferably, the second connecting member 6 is a nickel sheet. The second connecting member 6 and the first connecting member 5 are arranged on the same side or on different sides, and the second connecting member 6 is welded to the housing 1 through the laser welding technology.

### Embodiment 3

Embodiment 3 provides an electronic product, including the lithium battery in Embodiment 2. The electronic product provided in Embodiment 3 can be a cellphone, a tablet, a computer, or the like. Types of the electronic product are not specifically limited herein.

In addition, it should be understood that although the description is described according to implementations, each implementation does not include only one independent technical solution, the description is for clarity only, and those skilled in the art should take the description as a whole, the technical solutions in the various embodiments may be appropriately combined to form other implementations understandable by those skilled in the art.

According to the disclosure and instruction of the above specification, those skilled in the art can make modifications and variations to the above examples. Therefore, the present disclosure is not limited to the above specific examples, and any obvious improvement, substitutions or variations made those skilled in the art on the basis of the present disclosure should fall within the protection scope of the present disclosure. In addition, although some specific terms are used in the specification, these terms are for convenience of description only and do not constitute any limitation to the present disclosure.

What it claimed is:

1. A battery housing, comprising:
a housing, an accommodation cavity is formed in the housing, an upper end and a lower end of the housing each has an opening, and a first through hole is formed in a side wall of the housing;
a first cover plate, the first cover plate is fixedly mounted at the upper end of the housing, and the first cover plate covers the opening at the upper end of the housing;
a second cover plate, the second cover plate is fixedly mounted at the lower end of the housing, and the second cover plate covers the opening at the lower end of the housing; and
the first cover plate is welded to an end face of the upper end of the housing, the second cover plate is welded to an end face of the lower end of the housing, a contact surface between the housing and the first cover plate is a horizontal plane, and a contact surface between the housing and the second cover plate is a horizontal plane.

2. The battery housing according to claim 1, wherein at least one of the first cover plate and the second cover plate is provided with an explosion-proof device.

3. The battery housing according to claim 1, wherein a liquid injection hole is formed on the side wall of the housing.

4. The battery housing according to claim 1, wherein the first cover plate and the second cover plate can be a rectangular structure or a circular structure.

5. The battery housing according to claim 1, wherein the housing has a thickness of 0.05-0.5 mm.

6. A lithium battery, comprising the battery housing according to claim 1, a battery cell (4), a first connecting member and a second connecting member, the battery cell is fixedly mounted inside the accommodating cavity, the first connecting member is inserted into the first through hole, and the second connecting member is fixedly mounted on the housing.

7. The lithium battery according to claim 6, wherein the battery cell is provided with a first tab and a second tab, the first tab is electrically connected to the first connecting member, and the second tab is electrically connected to the housing.

8. The lithium battery according to claim 6, wherein the first connecting member comprises a connecting piece, a first insulating piece, a second insulating piece and a pole, the connecting piece and the first insulating piece are fixedly installed inside the housing, the second insulating piece is fixedly installed outside the housing, and the pole sequentially passes through the second insulating piece, the first through hole, the first insulating piece and the connecting piece.

9. The lithium battery according to claim 6, wherein the second connecting member is a nickel sheet.

10. An electronic product, comprising the lithium battery according to claim 6.
